(19) United States
(12) Patent Application Publication
(10) Pub. No.: US 2004/0062475 A1
(43) Pub. Date: Apr. 1, 2004

(54) Optical multiplexing/demultiplexing device

(76) Inventors: Milan Momcilo Popovich, Leicester (GB); John James Storey, Nottingham (GB)

Correspondence Address: JERRY RICHARD POTTS, 3248 VIA RIBERA, ESCONDIDO, CA, 92029, US

(21) Appl. No.: 10/467,407

(22) PCT Filed: Feb. 4, 2002
(86) PCT No.: PCT/GB02/00499

(30) Foreign Application Priority Data
Oct. 19, 2001 (GB) 0125140.4

(51) Int. Cl. G02B 6/26

(52) U.S. Cl. 385/27; 385/140

(57) ABSTRACT

An optical device comprises a waveguide assembly having a number of core portions along which radiation can propagate from an input port to an output port and cladding portions abutting said core portions. Each core portion is adapted to receive a beam composed of a respective wavelength band of radiation. The device also comprises a demultiplexer for separating a signal comprising a plurality of channels into separate channel beams for input into the waveguide and/or a multiplexer fro receiving the beams from the waveguide and recombining them into a single signal. Preferably, the waveguide incorporates optical attenuation means operative on the beams. In one embodiment, the core portions and/or abutting cladding portions are comprised of a polymer-dispersed liquid crystal material whose refractive index can be varied by the application of an electrical stimulus.

This application is a continuation-in-part of International Application PCT/GB02/00499 filed Feb. 4, 2002, which designated the United States.

### FIELD OF THE INVENTION

This invention relates to an optical device incorporating a multiplexer and/or a demultiplexer. In particular, but not exclusively, the invention relates to such an optical device for use in telecommunications.

### BACKGROUND OF THE INVENTION

Demultiplexer devices are known which are operative to receive an optical signal comprising a plurality of discrete channels and to separate those channels into respective beams. A known type of demultiplexer device for telecommunication dense wavelength Division multiplexing (DWDM) systems is based upon a grating architecture. Typically, an input light from a fibre is incident (either in transmission or reflection) upon a precision grating and the resulting dispersed spectrum is collected in a fibre array. The collection optics may incorporate an array of micro-lenses, which collect the appropriate spread of wavelengths into a given fibre in order to conform to recognized wavelength channels. Because the spatial separation of the wavelength channels is not even, it is necessary to construct customized fibre blocks to allow for the variability of channel spacing as the wavelengths fan out. Typically, these custom-made fibre blocks are based on non-standard 80-micron fibre to provide for a reasonable channel-to-channel separation.

In order to extend the functionality of a multiplexer, it is often that case that a multi-channel variable optical attenuator (VOA) is connected to each of the output channels in order to allow channel equalization. The multiple channels are then recombined in a multiplexer.

It is also known to use prisms and interference filters rather than gratings in a demultiplexer to separate the channels of an optical signal in respective beams. Multiplexer devices are also known which devices are operative to receive a plurality of beams, each comprising a separate channel, and to combine those beams into a single optical signal. Such multiplexers are essentially the reverse of a demultiplexer and can use grating architectures, prisms or interference filters to combine the separate beams into a single signal.

### SUMMARY OF THE NVENTION

It is an object of the present invention to provide an improved optical device incorporating a demultiplexer and/or a multiplexer into which an optical attenuation functionality can be integrated. It is a yet further object of the present invention to provide an optical device incorporating a demultiplexer and/or a multiplexer which avoids the need for a customized fibre block.

In accordance with a first aspect of the invention, there is provided an optical device comprising: a waveguide assembly having a number of core portions along which radiation can propagate from an inlet port to an outlet port and cladding portions abutting said core portions, each core portion being adapted to receive a beam composed of a respective wavelength band of radiation; and a multiplexer operative to combine the respective beams into a single optical signal.

In accordance with a second aspect of the invention, there is provided an optical device comprising: a demultiplexer operative to receive an optical signal comprising a plurality of channels, each channel comprising a respective wavelength band of radiation, and to separate the channels into respective beams, and a waveguide assembly having a number of core portions along which radiation can propagate from an inlet port to an outlet port and cladding portions abutting said core portions, each core portion being adapted to receive one of said beams. Preferably, the waveguide assembly incorporates an optical attenuation means operative with regard to at least one of the respective beams.

In a particularly preferred arrangement, the waveguide assembly comprises a switchable waveguide device in which, in result of at least one of the core portions, the device can be switched between first and second states in which the refractive indices of said at least one core portion and its abutting cladding portion are respectively substantially matched or substantially unmatched. More preferably, the waveguide assembly is switchable in respect of each of the core portions independently, to allow selective attenuation of each of the beams. In such an arrangement, the abutting cladding portions and/or the core portions may comprise a polymer-dispersed liquid crystal material whose refractive index can be varied by the application of an electrical stimulus.

Preferably, the waveguide assembly comprises a plurality of discrete waveguide devices each having a single core portion and an abutting cladding portion.

Alternatively, the waveguide assembly is constructed as a monolithic assembly having a common substrate supporting a plurality of core portions, in which case, the waveguide assembly may comprise single layer of polymer-dispersed liquid crystal material forming the abutting cladding portions.

Preferably, each core portion incorporates a switchable assembly operative to reflect radiation back to the inlet port of the core portion when activated.

Preferably, the waveguide assembly further comprises coupler means associated with each core portion, the coupler means being operative to extract input energy from the core portion to facilitate control of the variation optical attenuation assembly.

Where the optical device is a device in accordance with the second aspect of the invention, the demultiplexer may be operative to disperse each of said channels in a direction dependant upon the wavelength band of radiation in the respective channel. In such an arrangement, the demultiplexer may comprise a diffraction grating or a prism and the demultiplexer may include collection optics to collect each selected wavelength band into a beam. The collection optics may comprise a micro-lens array.

Preferably, the inlet ports of the waveguide assembly are spaced to conform with the spatial separation of the respective beams input to the waveguide device. Preferably, the spatial separation of the core portions modulates over the length of the waveguide assembly.

In a particularly preferred embodiment, the outlet ports of the waveguide assembly are evenly spaced at standard 127 or 250-micron pitch for interfacing with standard 125-micron fibre ribbon.

Preferably, an optical device in accordance with the second aspect of the invention also comprises a multiplexer which is adapted to receive the respective beams after they have passed through the waveguide assembly and to combine the beams into a single beam.

### BRIEF DESCRIPTION OF THE DRAWINGS

The invention will now be further described by way of example only, with reference to the following drawings in which:

FIG. 1 is a schematic view of a prior art demultiplexer;

FIG. 2 is a sectional schematic view of an optical device comprising a demultiplexer in accordance with the present invention;

FIG. 3 is a sectional schematic view of a waveguide assembly incorporating a 2×2 switch for use in the device of FIG. 2;

FIG. 4 is a sectional schematic view of a waveguide assembly comprising a coupler means for use in the device of FIG. 2;

FIG. 5 is a sectional schematic view of an optical device comprising a multiplexer in accordance with the invention

FIG. 6 is a sectional schematic view of a further embodiment of an optical device comprising a multiplexer in accordance with the invention;

FIG. 7 is a sectional schematic view of a yet further embodiment of an optical device comprising a multiplexer in accordance with the invention; and,

FIG. 8 is a sectional schematic view of an optical device comprising a demultiplexer and a multiplexer in accordance with the invention.

### DETAILED DESCRIPTION OF THE INVENTION

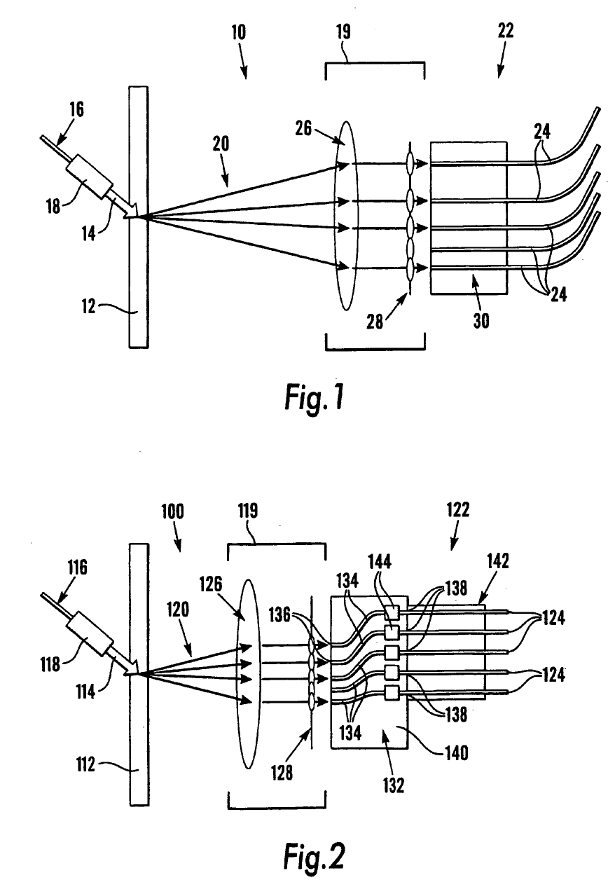

FIG. 1 shows a known optical demultiplexer 10 from telecommunications DWDM system. The demultiplexer 10 comprises a precision grating 12 which is operative to disperse radiation 14 incident on the grating. In this case the radiation 14 is incident on the grating in transmission from an input fibre 16 having a collimator 18. However, the radiation may be incident on the grating in reflection. Optical means, indicated generally at 19, are operative to collect the dispersed radiation 20 into a fibre array 22 having a number of output fibres 24. The arrangement is such that each of the output fibres 24 receives a spread of wavelengths conforming to recognised wavelength channels such as those of the ITU Grid. For this purpose, the optical means may comprise a collection lens 26 and a micro-lens array 28. Because the spatial separation of the wavelength channels is not even, the fibre array 22 comprises a customised fibre block 30 which is based on non-standard 80-micron fibre in order to obtain reasonable channel-to-channel separation.

FIG. 2 shows an optical demultiplexer device 100 in accordance with the invention. Components of the demultiplexer device 100 which are the same as those of the demultiplexer 10 described with reference to FIG. 1 are given in the same reference numeral but increased by 100. The demultiplexer 100 comprises a precision grating 112 which is operative to disperse radiation 114 incident on the grating. In this case the radiation 114 is incident on the grating in transmission from an input fibre 116 having a collimator 118, however, the radiation may be incident on the grating in reflection. Optical means, indicated generally at 119, is operative to collect the dispersed radiation 120 for input into a fibre array 122 having a number of output fibres 124. The arrangement is such that each of the output fibres 124 receives a spread of wavelengths conforming to recognised wavelength channels such as those of the ITU Grid. For this purpose, the optical means may comprise a collection lens 126 and a micro-lens array 128 which collects the dispersed radiation 120 into beams each comprising a selected wavelength band of radiation. Demultiplexer 100 differs from the demultiplexer 10 in that a wavelength assembly 132 is used to guide the light collected into the wavelength channels from the micro-lens array to the output fibres 124.

The waveguide assembly 132 comprises a number of core portions or wave guides 134 along which radiation can propagate from an input port 136 to an output port 138. The core portions are surrounded by a cladding material 140. The number of core portions corresponds to the number of wavelength channels into which the radiation is collected and the input ports are spaced to conform with the spatial separation of the channels. As can be seen from FIG. 2, the core portions are arranged so that their spatial separation modulates along the length of the waveguide assembly such that the output ports 138 are evenly spaced. Preferably the output ports are arranged to be spaced at a standard 127 or 250-micron pitch for interfacing with a standard 125-micron fibre ribbon 142.

In addition to allowing interfacing with a standard fibre ribbon, the incorporation of a waveguide assembly into the demultiplexer in accordance with the invention allows the input channel spacing to be reduced whilst maintaining acceptable channel separation. This brings size and cost advantages.

Furthermore, if the waveguide assembly comprises a switchable waveguide device, it is possible to integrate an optical attenuation and preferably a variable optical attenuation (VOA) functionality into the demultiplexer. Such a switchable waveguide device comprises a core portion along which radiation can propagate, and a cladding portion abutting the core portion. At least one of the core and cladding portions are composed of a polymer-dispersed liquid crystal (PDLC) material whose refractive index can be varied by the application of an electrical stimulus. The device is switchable by application of the stimulus between first and second conditions in which the refractive indices of the core and cladding portions are respectively substantially matched or substantially unmatched. By controlling the refractive index of the cladding relative to that of the core, it is possible to control the characteristics of the radiation propagating within the core. In particular, it is possible to control coupling of the radiation propagation between the core and the cladding. For example, when the refractive indices of the core and the cladding are matched, radiation can propagate from the core into the cladding to create a loss path. The construction of a switchable waveguide device as such does not form part of the present invention.

The waveguide assembly 132 is constructed so that a portion 144 of the cladding material 140 abutting each core portion 134 comprises a polymer-dispersed liquid crystal (PDLC) material. The waveguide assembly also comprises suitable electrodes (not shown) arranged so that each of the abutting cladding portions 144 can be independently switched between a first state in which its refractive index substantially matches that of its respective core portion 134 and second state in which its refractive index is not matched with that of its respective core portion. By appropriate switching of the abutting cladding portions 144, the beams of radiation propagated along each of the core portion can be independently attenuated to provide for channel equalisation. Each core portion may be optically homogeneous or its refractive index may vary along its length. The core portions may also embody holographic fringes in the form of a Bragg grating (not shown), these fringes forming a switchable reflective hologram. When activated, this hologram reflects radiation propagating along the core portions 134 in the reverse direction towards the input ports 136. The waveguide assembly 132 may comprise a number of separate waveguide devices each having a single core portion and abutting cladding portion. The separated waveguide devices being held at a suitable spacing such that the inlet ports 138 are in alignment with the wavelength channels emanating from the micro-lenses.

Alternatively, the waveguide assembly may be constructed as a monolithic assembly in which a number of core portions and cladding portions are built up on a common substrate. In this type of construction, a single layer of PDLC material may be used to provide the switchable abutting cladding portions with an appropriate arrangement of electrodes to enable independent attenuation of each of the channels.

The waveguide assembly may also comprise 2×2 switches such that an Optical Add Drop Multiplexer (OADM) functionality can be added. Such switches could be based on electromechanical mirrors or optical solid state assemblies such as acousto-optic couplers or electro-optic couplers. In a preferred embodiment switching is provided by changing the refractive index in a region of PDLC material between adjacent core portions.

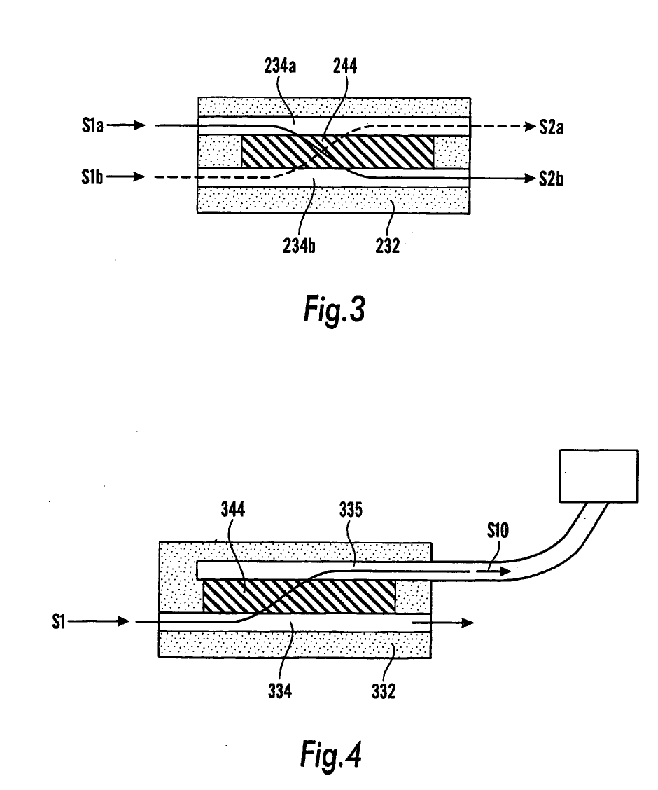

An example of such a PDLC coupler 2×2 switch is shown in FIG. 3 which shows a waveguide assembly 232 having two core portions 234a, 234b. The core portions each being abutted by a common PDLC region 244. Input signals S1a and S1b, propagate inside the two core portions. An electric field applied to the PDLC region changes the average refractive index of the PDLC region, causing a portion of radiation propagating in each core portion to be evanescently coupled to its companion core portion, giving output signals S2a and S2b.

Many different switching configurations are possible. By recording holographic Bragg gratings of appropriate spatial frequency into the PDLC region (i.e. Holographic-PDLC or H-PDLC as opposed to PDLC) it is possible to provide wavelength selective switching such that only predetermined wavelengths are switched between core portions. Broad band switching can be provided using bulk PLC or, alternatively, on/off resonance H-PDLC Bragg gratings to provide the required average refractive index change. In this case, the input signal S1a would be converted to the output signal S2b and the input signal S1b would be converted to the output signal S2a. It will be clear to those skilled in the art that many different switching architectures can be constructed to allow switching to take place between different combinations of core portions 234. In further embodiments of the invention, switching could take place between the core portions 234 and additional wave guides external to but operationally coupled to the waveguide assembly 232.

The waveguide assembly 132 may also comprise coupler means associated with one or more of the core portions, each coupler means being operative to extract input energy from its respective core portion which energy may be used to control the VOA means.

FIG. 4 shows an example of a monitoring assembly based on an electro-optic coupler. The monitoring systems comprises a core portion 334 and a second core portion 335 which is operationally linked to the first core 334 by a region of PDLC material 344, both core portions being contained in a waveguide assembly 332. By applying and electric field to the PDLC region the resulting change in the average refractive index causes a portion of light signal S1 propagating down the core region 334 to be evanescently coupled to the core portion 335, giving an output signal S10. The signal S10 is directed to a photodetector 360 which may be connected to a control system.

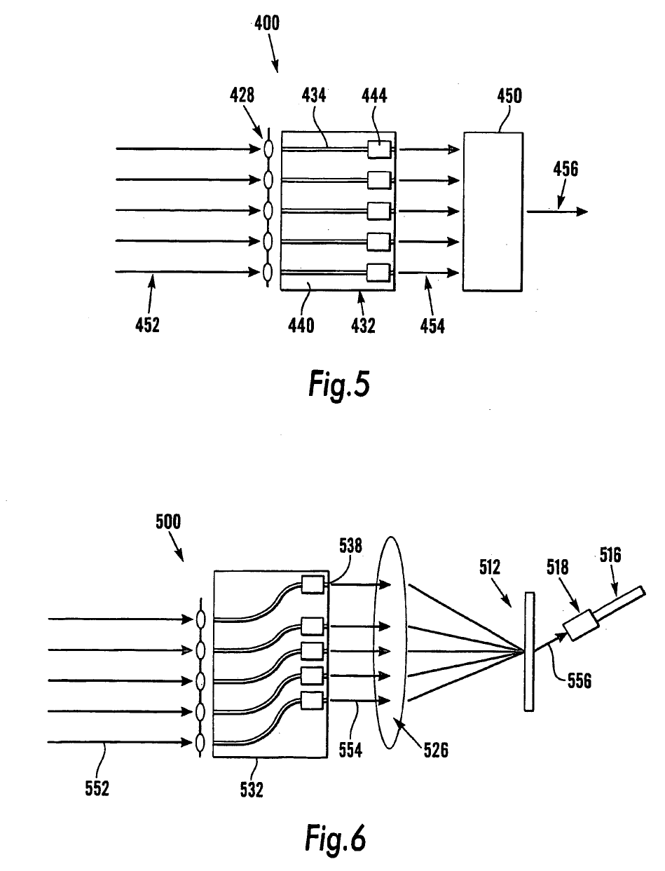

The invention is not limited to optical devices comprising a demultiplexer but can also be applied to optical devices comprising a multiplexer. FIGS. 5 to 8 show examples of how a waveguide assembly can be used in a multiplexer device. FIG. 5 shows an optical multiplexer device, indicated generally at 400, comprising a micro-lens array 428, a waveguide assembly 432 and a multiplexer 450. Input beams 452 to the device may have been generated by a demultiplexer such as the grating 112 used in the demultiplexer device of the embodiment shown in FIG. 2. The waveguide assembly 432 is essentially the same as the waveguide device 132 described above in relation to FIG. 2 and comprises core portions 434 surrounded by cladding material 440. The waveguide 4434 also comprises PDLC portions 444 to provide variable optical attenuation of the input beams 452, so that the amplitude of each of the input beams 452 can be modulated to give rise to an output beam 454. As with the demultiplexer device described above, each of the beams corresponds to a discrete wavelength channel. The multiplexer 450 is operative to combine the output beams 454 from the waveguide assembly 432 into a single output beam 456. The multiplexer could be of any suitable type and could, for example, be based on a dispersive optical device such as a grating or a prism.

FIG. 6 shows a further embodiment of an optical device 500 comprising a multiplexer based on a diffraction grating 512. Because of the dispersive nature of the grating 512, it is necessary for the output beams 54 from the waveguide assembly to have a non-uniform spatial separation. This is achieved by modulating the spatial separation of the core portions along the length of the waveguide assembly to ensure that the output ports 538 have the required spatial separation. Lens 526 focuses the output beams 554 onto the grating 512 which combines the output beams 554 into a single optical signal 556 which is received by an output fibre 516 via a collimator 518.

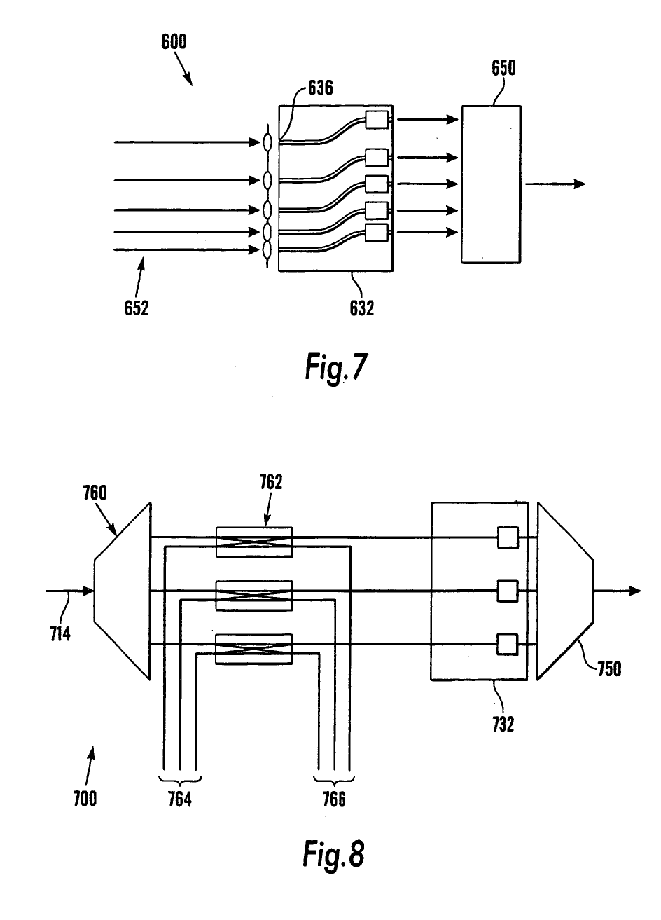

FIG. 7 shows a further embodiment of an optical device 600 comprising a multiplexer. In this embodiment, the spatial separation of the input ports 636 of the waveguide device 632 is non-uniform so as to conform with the non-uniform spatial separation of the input beams 652 which have been produced by a demultiplexer based on a dispersive optical device such as a grating or prism.

Finally, FIG. 8 shows an example of how a multiplexer device in accordance with the second aspect of the invention can be incorporated into an OADM architecture. FIG. 8 shows an optical device 700 comprising multiplexer device having a waveguide assembly 732 and a multiplexer 750. The multiplexer device may be constructed in accordance with any of the multiplexer devices described above with reference to FIGS. 5 to 7. In addition, the optical device 700 further comprises a demultiplexer 760 and a set of 2×2 switches 762. Input optical communications links 764 to the switches 72 provide the ADD channels, whilst output optical communications links 766 to the switches provide the DROP channels. The 2×2 switches 762 may constructed and operated in the same manner as the switches described above in relation to FIG. 3, and could be integrated within the waveguide assembly 732 itself.

Whereas the invention has been described in relation to what is presently considered to be the most practical and preferred embodiments, it is to be understood that the invention is not limited to the disclosed arrangements but rather is intended to cover various modifications and equivalent construction included within the spirit and scope of the invention. For example, in the description above it is envisaged that the cladding material will be constructed fro PDLC material, it is possible alternatively or additionally to form the core portions from this material. Moreover, whilst it is preferred that VOA functionality is provided using the electro-optic techniques based on switchable PDLC material as described above, other forms of VOA could be used, for example, assemblies in which refractive index control is provided by means of thermo-electric or acousto optic means. Also, whilst in the preferred embodiments a grating architecture is used to separate or to combine the separate the channels, other forms of demultiplexer/multiplexer could be used. Whilst the embodiments show the use of a micro-lens array to couple the beams to the waveguide assembly, this is not essential. Those skilled in the art will understand that any suitable means of collecting the selected wavelength bands of radiation into the waveguide assembly can be used.

Furthermore, although the invention has been descried with reference to its application in telecommunications assemblies, it can be used in other areas of technology as well, such as optical displays systems.

What is claimed is:

1. An optical device comprising:
a waveguide assembly having a plurality of core portions along which radiation can propagate from an input port to an output port, each said core portion being adapted to receive a beam composed of a respective wavelength band of radiation, wherein said waveguide assembly is operative to apply a selective optical attenuation with respect to at least one of said beams;
at least one cladding portion abutting said core portions, said at least one cladding portion comprising a polymer-dispersed liquid crystal material whose refractive index can be varied by the application of an electrical stimulus; and
a multiplexer operative to combine the respective beams into a single optical signal.

2. The optical device of claim 1 wherein the waveguide assembly comprises a plurality of discrete waveguide devices each having a single core portion and an abutting cladding portion.

3. The optical device of claim 1 wherein the waveguide assembly is constructed as a monolithic assembly having a common substrate supporting a plurality of core portions.

4. The optical device of claim 1, wherein the waveguide assembly comprises a single layer of polymer dispersed liquid crystal material forming the abutting cladding portions.

5. The optical device of claim 1, wherein each core portion incorporates a switchable assembly operative to reflect radiation back to the inlet port of the core portion when activated.

6. The optical device of claim 1 wherein the waveguide assembly further comprises coupler means associated with each core portion, the coupler means being operative to extract input energy from the core portion to facilitate control of the variable optical attenuation assembly.

7. The optical device of claim 1 wherein the input ports of the waveguide assembly are spaced to conform with the spatial separation of the respective beams input into the waveguide device.

8. An optical device comprising:
a demultiplexer operative to receive an optical signal comprising a plurality of wavelength channels and to separate the channels into respective beams;
a waveguide assembly having a plurality of core portions along which radiation can propagate from an input port to an output port, each core portion being adapted to receive one of said beams, wherein said waveguide assembly is operative to apply a selective optical attenuation with respect to at least one of said beams; and
at least one cladding portion abutting said core portions, said at least one cladding portion comprising a polymer-dispersed liquid crystal material whose refractive index can be varied by the application of an electrical stimulus.

9. The optical device of claim 8, wherein the waveguide assembly comprises a plurality of discrete waveguide devices each having a single core portion and an abutting cladding portion.

10. The optical device of claim 8 wherein the waveguide assembly is constructed as a monolithic assembly having a common substrate supporting a plurality of core portions.

11. The optical device of claim 8 wherein the waveguide assembly comprises a single layer of polymer dispersed liquid crystal material forming the abutting cladding portions.

12. The optical device of claim 8 wherein each core portion incorporates a switchable assembly operative to reflect radiation back to the inlet port of the core portion when activated.

13. The optical device of claim 8 wherein the waveguide assembly further comprises coupler means associated with each core portion, the coupler means being operative to extract input energy from the core portion to facilitate control of the variable optical attenuation assembly.

14. The optical device of claim 8 wherein the demultiplexer is operative to disperse each of said channels in a direction dependent upon the wavelength band of radiation in the respective channel.

15. The optical device of claim 8 wherein the input ports of the waveguide assembly are spaced to conform with the spatial separation of the respective beams input into the waveguide device.

16. The optical device of claim 8 wherein the device further comprises a multiplexer adapted to receive the respective beams after they have passed through the waveguide and to combine the beams into a single optical signal.
